(19) United States
(12) Patent Application Publication
(10) Pub. No.: US 2006/0259947 A1
(43) Pub. Date: Nov. 16, 2006

(54) Method for enforcing a Java security policy in a multi virtual machine system

(75) Inventors: Jyrki Aarnos, Kangasala (FI); Pasi Pentikainen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/126,651

(22) Filed: May 11, 2005

(51) Int. Cl. H04L 9/00

(52) U.S. Cl. 726/1

(57) ABSTRACT

A system and method for enforcing a security policy in a distributed system. A request is transmitted to a receiving program on a first virtual machine to permit a requesting program on a second virtual machine to access the receiving program. A first call stack is accessed in the target virtual machine to determine whether the requesting program is permitted to access the receiving program. A second call stack, in the originating virtual machine, is accessed to determine whether the requesting program is permitted to access the receiving program. If the requesting program is permitted to access the receiving program, the receiving program is invoked. If the requesting program is not permitted to access the receiving program a signal indicating access is not allowed is transmitted.

### FIELD OF INVENTION

The present invention generally relates to security enforcement in software applications. More specifically, the present invention relates to a method for enforcing a common security policy across software components residing on multiple virtual machines.

### BACKGROUND OF THE INVENTION

A virtual machine is an abstract computing machine. The virtual machine is equipped with a set of instructions and has the capability to access memory locations. The Java 2 Platform Security Architecture, which can be found on the internet at http://java.sun.com/j2se/1.5.0/docs/guide/security/spec/security-spec.doc.html, herein incorporated by reference in its entirety, defines the way policy enforcement and permission checks are implemented in a single virtual machine. Permission checks allow secure access to programming resources. For example, permission checks are executed when a method is called that requires its caller to have certain permissions to be able to execute the method.

In a standard Java system architecture, the AccessController class, based on the security policy currently in effect, is used to decide whether access to a critical system resource is to be allowed or denied. The AccessController checkPermission method examines the current execution context and determines whether the requested access is allowed. If access is allowed the checkPermission method returns quietly. In the alternative, an AccessControlException is thrown signaling that access is not allowed.

Generally, access control checking occurs in a thread of computation that has a chain of multiple callers. These callers may be methods or other programming resources. The checkPermission method of the AccessController class is invoked by the most recent caller. If any caller in the call chain does not have the requested permission an exception (AccessControlException) is thrown. When permission checking is requested, the thread state (as reflected by the current state, including the current thread's call stack) is examined and a decision is reached to either deny or grant the particular access requested. The call stack lists the routines, procedures, method, etc. that are currently loaded. Every method in a call chain is listed in the call stack. Thus, each method is examined to determine whether it has the permissions necessary to call the requested or target method.

The doPrivileged method in the AccessController class allows code in a class instance to inform the AccessController that a body of code is “privileged” in that it is solely responsible for requesting access to its available resources no matter what other code interacts with it. A program or caller can be marked as “privileged” by calling the doPrivileged method. When making access control decisions, the checkPermission method stops checking if it reaches a caller that was marked as “privileged.” If that caller has the specified permission, checkPermission returns quietly and no further checking is done. In the alternative, if the caller does not have permission an exception is thrown. Permission is only granted if both the privileged code has the permission and the subsequent callers in the call chain up to the checkPermission call have permission.

FIG. 4 shows a software application system residing on a single virtual machine according to the prior art. The system has programming resources A-E. A programming resource, for example, may be a method, a class, a programming module, a program a package or a collection of packages. For illustrative purposes only, the programming resources in FIG. 4 will be described as containing methods A-E. In object-oriented programming, a method is a programmed procedure that is defined as part of a class and included in any object of that class. A class (and thus an object) can have more than one method and a method can be re-used in multiple objects.

As shown in FIG. 4, each programming resource may have different permissions. Permissions are established by a security policy and determine whether a certain caller may access and use other programming resources. As shown in FIG. 4, access to programming resource C requires the programming resource calling C to have permission “Y” and “X.” Similarly, the programming resource E requires the programming resource calling E to have a permission “X.” The programming resource D has the permission X. Here, programming resources C-E provide a service that requires security permissions. The programming resource A accesses these permissions through another programming resource B. The programming resource B has both permission X and Y. Programming resource B calls programming resource C using a doPrivileged method call.

As shown in FIG. 4, the programming resource A calls programming resource B. B provides a secure service to A. Here, the programming resource A does not require permissions X or Y needed to access programming resources C and E because the programming resource B calls C using a doPrivileged call. The programming resource C receives the request from programming resource B and then makes a call to the Java security system, represented in FIG. 4 as the Security Manager. Here, the Security Manager determines whether programming resource B has permission to access programming resource C. The security system does this by examining the call stack. Here, an examination of the call stack will show that the programming resource B has been invoked and that programming resource B has permission to access programming resource C.

Next, programming resource C calls programming resource D. Programming resource D, which has permission “X,” then makes a call to programming resource E. Programming resource E requires permission “X,” and calls the security manager to determine whether the programming resource D has permission “X.” Similar to the procedure during the method call to C, the security manager examines the call stack. An examination of the call stack reveals the entire call chain that lead to programming resource D calling programming resource E. The security system searches through the call chain to evaluate whether each programming resource that made a call has the necessary permissions. Here, since the programming resource D, C and B has permission “X” the security manager allows programming resource D to call programming resource E. Once programming resource E has completed execution a return path is initiated which will eventually return control to the programming resource A.

As shown in FIG. 4, current Java security specifications are designed for single virtual machine implementations. Meanwhile, current technologies implementing software architecture are making use of distributed applications which may be run on one or more virtual machines. Unfortunately, the permission checking system used in a single virtual system is not usable in a distributed system. Generally, security on a distributed system is implemented by certificates, challenges, and passing the caller's role information between parts that trust each other (e.g. J2EE servers in one domain) and so on. While these measures function well they are not as uniform as the security policies implemented by the Java Security Architecture between applications residing on a single virtual machine. Therefore, a method and system for enforcing a uniform and robust security policy, characteristic of a single virtual machine on a multiple virtual machine system is needed.

### SUMMARY OF THE INVENTION

The present invention addresses the above-identified shortcomings by providing, according to one embodiment of the invention, a method of enforcing a security policy in a multiple virtual machine system. The method transmits a request to a receiving program residing on a target virtual machine to permit a requesting program residing on a originating virtual machine to access the receiving program on the target virtual machine. Then the method examines a call stack residing on the target virtual machine to determine whether the requesting program is permitted to access the receiving program. Next, the method receives a request from the target virtual machine to examine a call stack residing on the originating virtual machine to determine whether the requesting program is permitted to access the receiving program. The method examines the call stack residing on the originating virtual machine to determine whether the requesting program is permitted to access the receiving program. Finally, if the requesting program is permitted to access the receiving program, the method invokes the receiving program and transmits a successful return.

According yet another embodiment of the present invention, a method of enforcing a security policy in a multiple virtual machine system receives an request from a requesting program residing on an originating virtual machine to permit the requesting program access to a receiving program residing on a target virtual machine. The method examines a call stack residing on the target virtual machine to determine whether the requesting program is permitted to access the receiving program. If the requesting program is not permitted to access the receiving program, the method receives a signal from the originating virtual machine indicating access is not permitted.

These and other objects, advantages and features of the invention, together with the organization and manner of operation thereof, will become apparent from the following detailed description when taken in conjunction with the accompanying drawings, wherein like elements have numeral throughout the several drawings described below.

### BRIEF DESCRIPTION OF THE DRAWINGS

FIG. 1 is an overview diagram of a system within which the present invention may be implemented.

FIG. 2 is a perspective view of a mobile telephone that can be used in the implementation of the present invention.

FIG. 3 is a schematic representation of the telephone circuitry of the mobile telephone of FIG. 2.

FIG. 4 is a block diagram of a single virtual machine system implementing a security policy according to the prior art.

FIG. 5 is a block diagram of a distributed system enforcing a security policy according to one embodiment of the prior art.

FIG. 6 is a flow chart showing the decision making process according to one embodiment of the present invention.

FIG. 7 is a flow chart showing the decision making process according to one embodiment of the present invention.

FIG. 8 is a flow chart showing the decision making process according to one embodiment of the present invention.

FIG. 9 is a flow chart showing the decision making process according to one embodiment of the present invention.

FIG. 10 is a flow chart showing the decision making process according to one embodiment of the present invention.

FIG. 11 is a block diagram of the present invention implemented on a distributed system according to one embodiment of the present invention.

FIG. 12 is a block diagram of the present invention implemented on a distributed system according to one embodiment of the present invention.

### DETAILED DESCRIPTION OF THE PREFERRED EMBODIMENTS

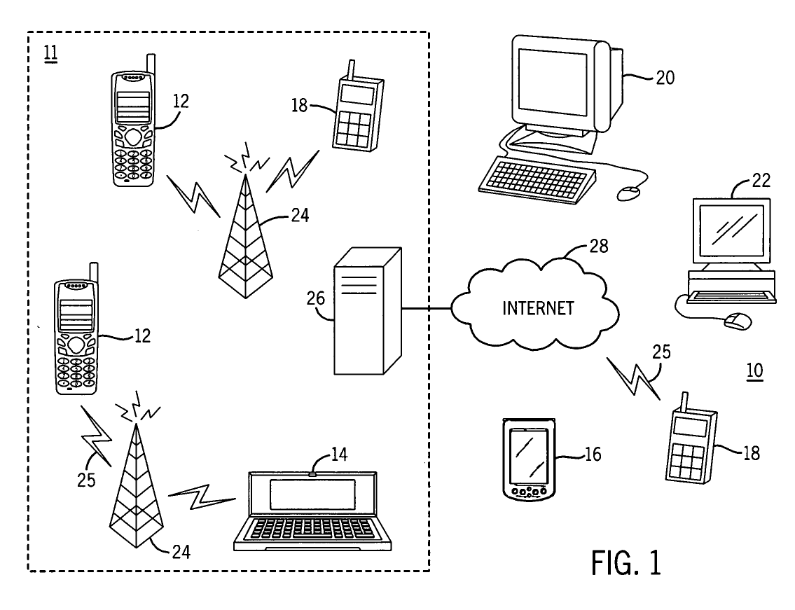

FIG. 1 shows a system 10 in which a Java environment implementing the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices. Further, the system may comprise a plurality of computer hardware systems including servers 26 and client work stations 20, laptops etc.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination personal digital assistant (PDA) and mobile telephone 14, a PDA 16, an integrated messaging device (IMD) 18, a desktop computer 20, a server and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

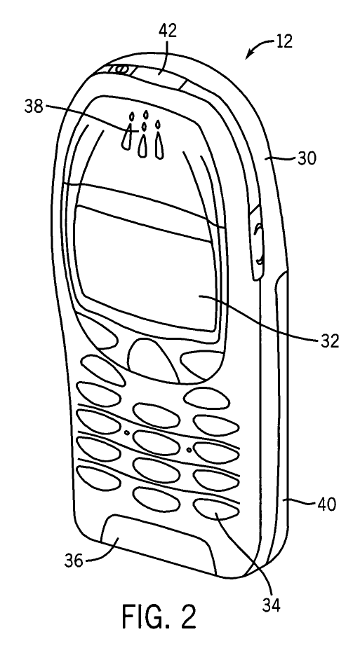

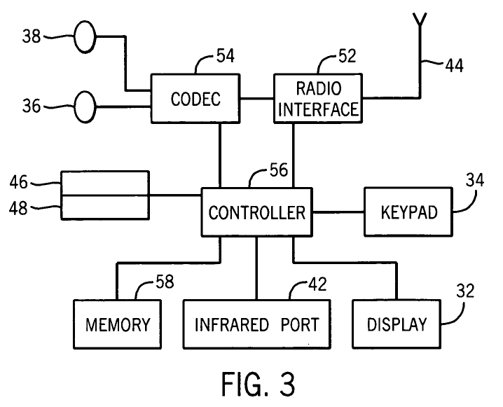

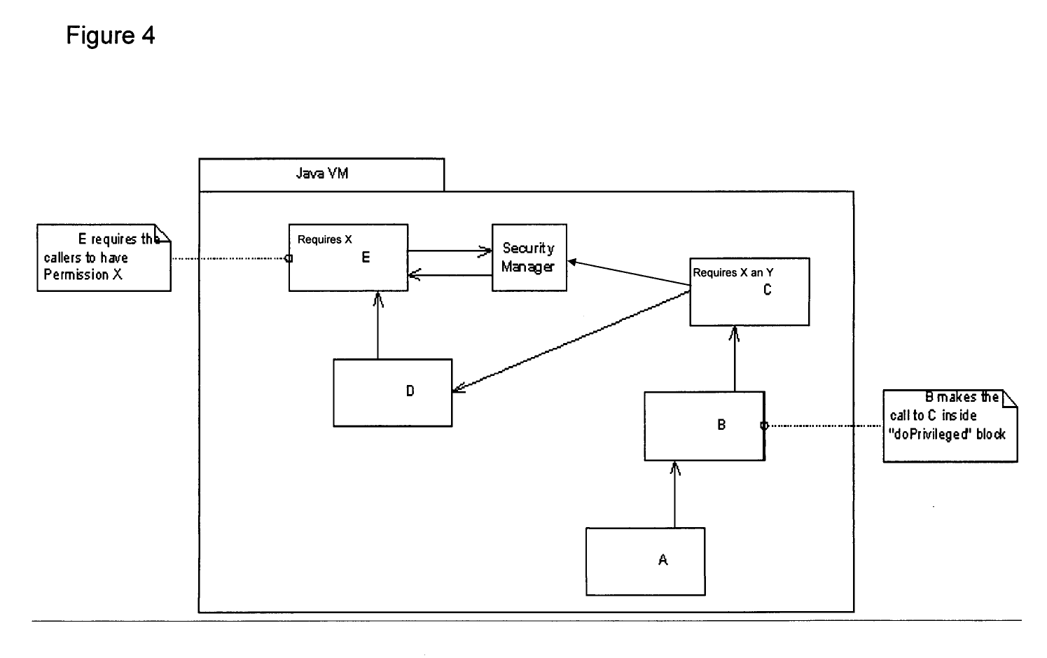

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32, a keypad 34, a microphone 36, an ear-piece 38, a battery 40 and a memory 58. Individual circuits and elements are all of a type well known in the art, for example in the Nokia range of mobile telephones.

According to one embodiment of the present invention, one ore more virtual machines may reside on a electronic device such as a mobile telephone 12, a combination mobile telephone/digital assistant 14, a PDA 16, desktop computer 20, a server 26 or notebook computer 22. According to another aspect of the present invention, a virtual machine may be housed on a computer program product. That computer program product may reside on an electrical device such as those mentioned above. Further, one or more virtual machines may reside on the same physical environment such as a server 26 or client computer system 20, 22.

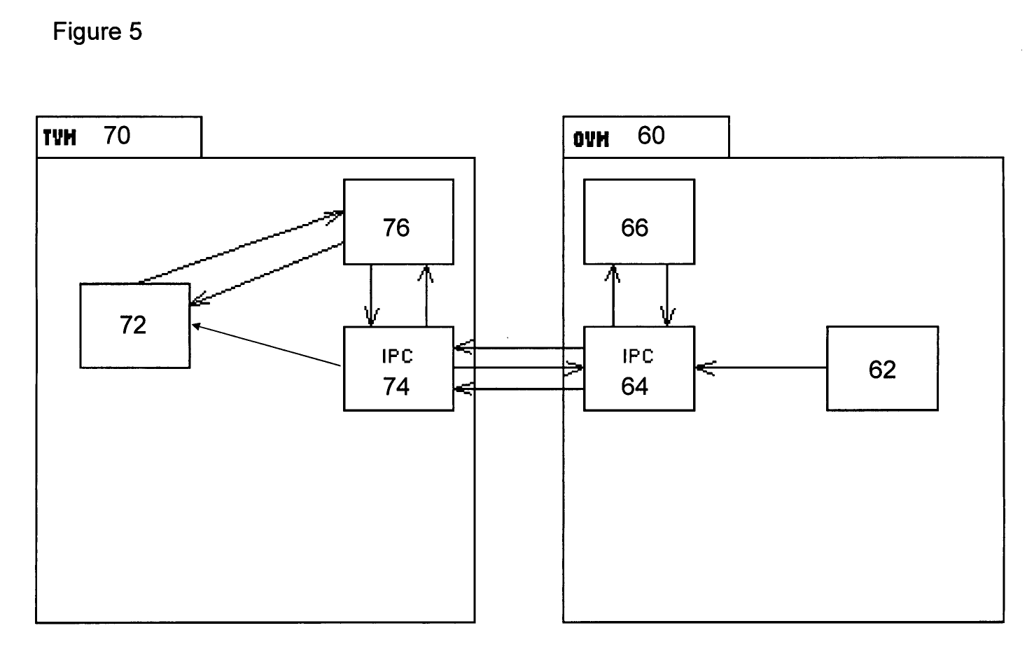

A distributed network, according to one embodiment of the present invention is shown in FIG. 5. In a distributed network (a system having more than one virtual machine), a requesting program 62 residing on a originating virtual machine (“OVM”) 60 may request the services of a receiving program 72 that resides on a target virtual machine (“TVM”) 70. It should be understood that the distributed network may include more than two virtual machines. In addition, one skilled in the art can comprehend how the method and system of the present invention is easily expanded to a system comprising a plurality of virtual machines. Further, one skilled in the art can comprehend how the method and system of the present invention is easily applied to a system consisting of one or more logical virtual machines that exist inside one or more virtual machine instances. Two virtual machines are illustrated here for simplicity and example only. The security managers 66 and 76 oversee security within their respective virtual machines. Communication between the security managers 66, 76 is achieved using a connectivity solution. Here, interprocess communication connections 64, 74 facilitate communication between the OVM 60 and TVM 70. Thus, security information may be shared between an OVM and TVM.

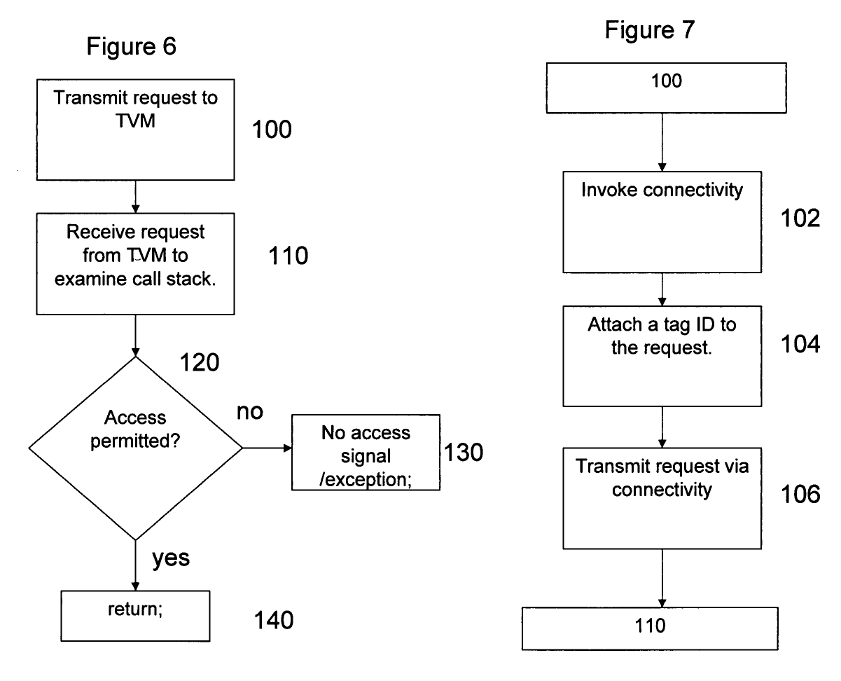

According to one embodiment of the present invention, as shown in FIG. 6, a requesting program 62 residing on an OVM 60 sends an request to a receiving program 72 residing on a TVM 70 (step 100). At step 110, the OVM 60 receives a request from the TVM 70. The OVM 60 is requested to examine a call stack residing on the OVM 60 to determine whether the requesting program 62 is permitted to access the receiving program 72 (step 120). If the requesting program 62 is permitted access to the receiving program 72 the OVM 70 transmits a successful return value e.g., “allow.” (140). Subsequently, the requesting program 62 is granted access to the receiving program 72.

As shown in FIG. 7, the transmitting step 100 further comprises invoking connectivity between the OVM 60 and the TVM 70. Connectivity can be established using known techniques such as interprocess communication, remote method invocation, shared memory etc. For example, the connectivity between the OVM 60 and TVM 70 is implemented using interprocess communication 64, 74. In step 104, a tag ID is attached to the request. The tag ID identifies the call stack residing on the OVM 60. Next, as seen in step 106, the request is routed from the requesting program 62 to the receiving program 72 via the connection between the OVM 60 and TVM 70.

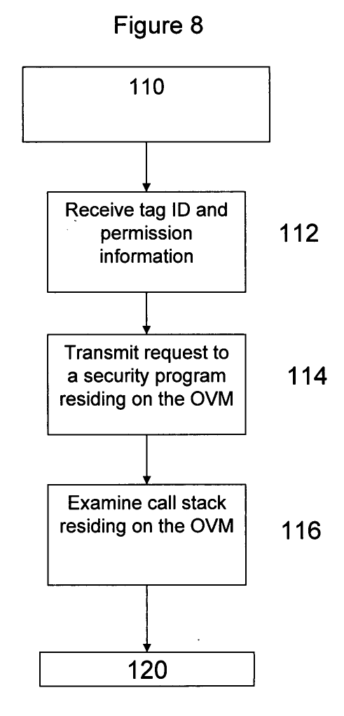

According to one embodiment of the present invention, the receiving step 110, as seen in FIG. 8, further comprises first receiving a tag ID (step 112) and information about a permission to be checked in the request from the TVM 70. A permission may be set by a security policy and generally indicates whether a requesting program 62 would have access to a receiving program 72. In step 114, the request including the tag ID and permission information is transmitted to a security program 66 residing on the OVM 60.

In turn, as seen in step 116, the security program 66 examines the call stack residing on the OVM 60. Generally the call stack is populated by every program, method, routine etc. residing on the OVM 60 that has been invoked for a particular thread. The security program 66 checks whether each item located in the call stack and associated with the requesting program 62 (i.e., in the requesting program's call chain) to determine whether each item has permission to access the receiving program 72. If one item in the call chain does not have the correct permissions based on a security policy then the requesting program 62 does not have permission to access the receiving program 72 and a signal indicating that access is denied (e.g., “deny”) is returned. (step 130). Consequently, a return value of “deny” causes the TVM 70 to through an exception. Alternatively, if all of the items residing on the call stack, associated with the requesting program 62 have the proper permissions then the requesting program 62 may access the receiving program 72 and a successful value (e.g., “allow”) is returned 140.

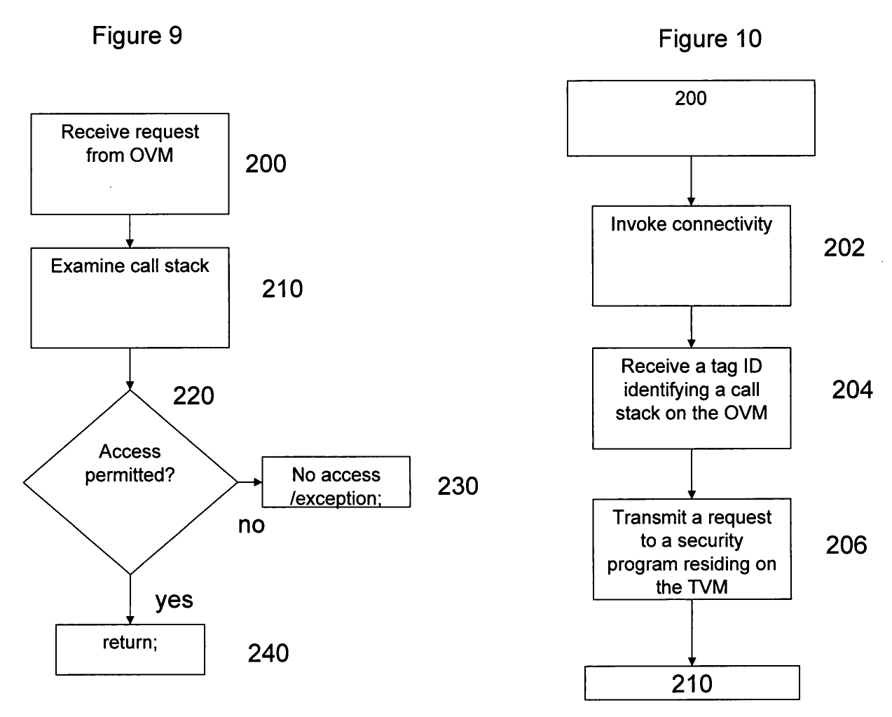

As seen in FIG. 9, according to another aspect of the invention, a receiving program 72 residing on a TVM 70 receives an request from a requesting program 62 residing on a OVM 60 (step 200). The system examines (step 210) the call stack residing on the TVM 70 to determine whether the requesting program 62 is permitted to access the receiving program 72. As seen in step 220, if the requesting program 62 is permitted to access the receiving program 72 then a successful return is received by the OVM 60. Alternatively, as shown in step 230 a signal indicating access is not allowed or an exception is received if the requesting program 62 is not permitted to access the receiving program 70.

As shown in FIG. 10, step 200 includes sub steps 202 and 204. In step 202, a connection is invoked between the OVM 60 and the TVM 70. As discussed above this connection can be implemented with various technologies. Preferably, however, the connection is implemented as an interprocess communication connection. In step 204, a tag ID identifying a call stack on the OVM 60 is received. Next, the request is submitted to a security program 76 residing on the TVM 70 (step 206).

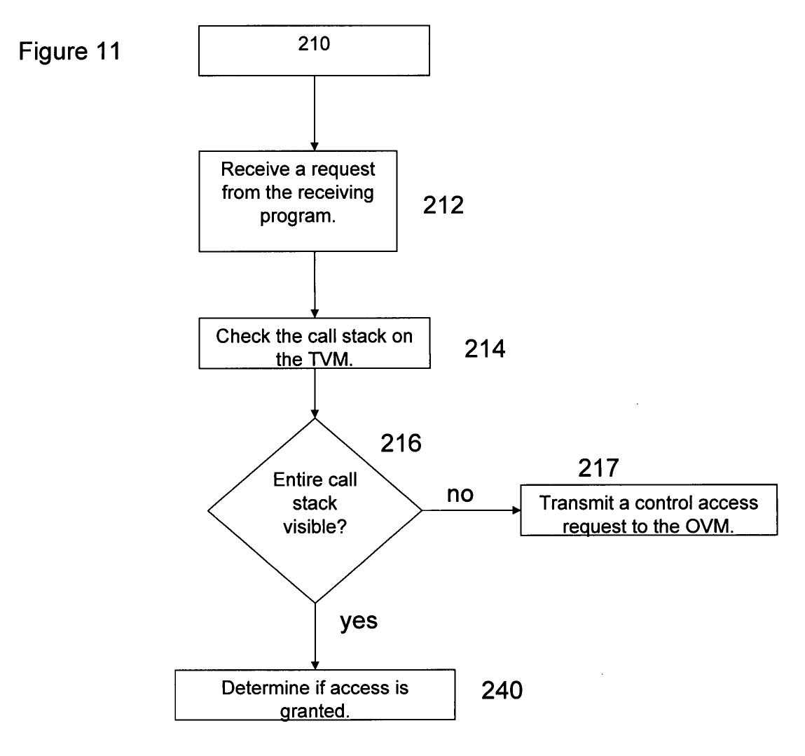

As shown in FIG. 11, step 210 includes several sub steps. The request sent from the receiving program 72 is received by a security program 76 residing on the TVM 70 in step 212. In step 212, the security program 76 examines the call stack residing on the TVM 70. The call stack is populated with all active methods, programs, etc. that have been invoked on the TVM 70. Here, since the original program request began on another virtual machine, i.e. the OVM 60, the call stack on the TVM 70 will not be populated with information about methods and programs invoked on the OVM 60. Thus, generally, the entire call stack will not be visible on the TVM 70 alone. Since the entire call stack is not visible, a access control request containing the tag ID and permission information for the receiving program 72 is transmitted to the OVM 60 (step 217).

In the alternative, if the entire call stack is visible the security program 76 has the information required to determine access rights (step 240). As shown in FIG. 9, steps 210-240, the TVM 70 receives a successful return 240 or a non access signal or exception 230 depending upon whether the requesting program 62 has permission to access to the receiving program 72.

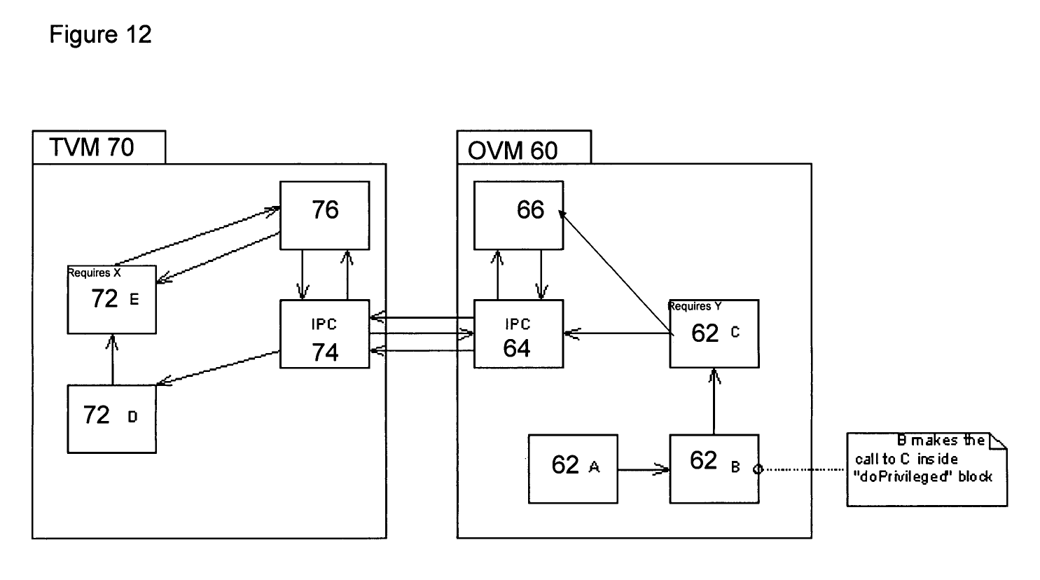

According to the principles of the present invention, a security policy is implemented over a distributed system shown in FIG. 12. Preferably, the distributed system is implemented using the Java Security Architecture. Thus, the distributed system is platform independent.

FIG. 12 shows a distributed system, according to one embodiment of the invention, in which there is a TVM 70 and a OVM 60. Programming resources 62A-62C reside on the OVM 60 and programming resources 72D-72E reside on the TVM 70. In addition, an IPC connection 64, 74 and a security program 66, 76 reside on each virtual machine 60, 70. Preferably, the security program is a Java-based security system. A programming resource 62A-62C or 72D-72E, for example, may be a method, class, package, collection of packages or other programming module.

As shown in FIG. 12, programming resource 62A makes a call to programming resource 62B. Programming resource 62B provides a service to programming resource 62A. According to one embodiment of the invention, the service is a “strong” or secure resource that requires special permissions established by a System Security Policy. The System Security Policy can be application specific, created by a user or a default policy provided with a standard programming specification. Preferably, the System Security Policy is implemented to integrate with the Java Security Architecture.

According to another embodiment of the invention, the programming resource 62B is solely responsible for requesting access to other available programming resources in the distributed system. Preferably, programming resource 62B calls the doPrivileged programming resource in the AccessController class. Thus, the programming resource 62B is privileged. The checkPermission method, when called, stops checking if it reaches a caller programming resource that is marked as privileged and quietly returns, indicating that the requesting resource is allowed to access to the receiving resource. If the caller programming resource does not have permission to access the receiving resource then a signal indicating access is not allowed is transmitted or an exception is thrown.

According to another embodiment of the present invention, the programming resource 62B calls a programming resource 62C. In turn, the programming resource 62C may make a call to a security program 66 residing on the OVM 60. The security program 66 determines whether the programming resource 62B has permission to access programming resource 62C. For example, as shown in FIG. 12, for a program to access programming resource 62C, the security policy implemented by the distributed system may require the program requesting access to programming resource 62C to have a permission “Y.” In turn, when the programming resource 62C receives a request, the security program 66 determines whether the requesting program, here programming resource 62B, has a permission “Y.”

In one embodiment of the present invention, the security program 66 checks the call stack (not shown). The call stack lists the routines, procedures, methods, and scripts etc. that are currently loaded. Every programming resource in a call chain is listed in the call stack. Thus, each programming resource is examined to determine whether it has the permissions necessary to call the requested or target programming resource. In the system shown in FIG. 12, the security program 66 stops checking the call stack after it determines that the requesting program, here programming resource 62B, has the required permission and has executed the doPrivileged method.

According to another aspect of the invention, the programming resource 62C makes a call to the programming resource 72D. As shown in FIG. 12, the programming resource 72D resides on a TVM and the programming resource 62C resides on a OVM. Thus, the system uses a connection interface, 64, 74 to allow programming resources that reside on different Virtual Machines to communicate. The connection interface may be implemented several different conventional ways, for example utilizing RPC or shared memory. Preferably, the connection interface is implemented using inter process communication (IPC) connectivity.

As shown in FIG. 12, when IPC connectivity is implemented, the programming resource 62C sends its request to a IPC connection 64 residing on the OVM. The IPC connection 64 communicates with a IPC connection 74 which is in direct communication with 72D and residing on the OVM. The IPC connection 64 in direct communication with the programming resource 62C communicates 62C's request to the IPC connection 74 residing on the TVM. In turn, programming resource 62C's request is communicated to programming resource 72D. In addition to transmitting 62C's request, the IPC connection 64 attaches a tag ID to the request. The tag ID identifies the call stack residing on the OVM 60. This call stack is the same call stack that was, for example accessed by the security manager 66 in determining whether programming resource 62B had the correct permissions.

According to another embodiment of the present invention, as shown in FIG. 12 the programming resource 72D makes a call to the programming resource 72E. In this embodiment, the programming resource 72E requires that the requesting program have a permission X in order to access its functionality. In turn, the programming resource 72E calls the security program 76 residing on the same virtual machine, TVM 70, as the programming resource 72E. The security program 76 accesses the call stack specific to the TVM. As seen in FIG. 12, the call stack would include only information concerning the programming resource 72D. However, based on the security policy, in order to determine whether the programming resource 72E can be accessed, all programming resources in the call chain must have the necessary permissions. In a system shown in FIG. 12, the remaining information about the other programming resources is on a call stack which resides on the OVM 60. Thus, the security program, utilizing the IPC connectivity described above, routes an access control request to the OVM. The access control requests includes as parameters the tag ID and information about the permission being checked. The IPCs 64, 74 communicate with each other. The security program residing on the OVM 60 receives a request to check the permission X and the call tag via the IPC connection. The security program 66 uses the call tag information to access the call stack. The security program 66 reviews the call stack and is able to determine whether all calls in the call chain were made with the proper permissions. If all calls in the call chain were made by programming resources with the required permissions the security program residing on the OVM transmits a signal to the security program 76 on the TVM, via the IPC connection, indicating that the access to programming resource 72E is allowable under the security policy. Once programming resource 72E has completed execution a return path is initiated which will eventually return control to the programming resource 62A.

In the case that programming resource 72D does not have permission “X,” the access control step fails on the TVM and the non-access signal or exception is passed normally to 72E, which passes it downward to 62B. In the case where programming resource 62B does not have the permission “X,” the access check fails on the OVM. In this case, the security program 66 sends the non-access signal through the IPC to 76 residing on the TVM 70. From 76, the non-access signal is returned back to 62B.

One advantage of the present invention is that a permission-checking procedure used in the robust security architecture that is present in a single virtual machine is expanded to a distributed system. The present invention retains the normal Java 2 permission based security control. This affords a distributed system the ability to execute robust security policies between applications residing on different virtual machines. In addition, the present invention eliminates the need for a developer to create new security applications or use outside software applications to implement security policies on a distributed system. In turn, the present invention drives down the cost of development and trims the development lifecycle. The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of enforcing a security policy in a multiple virtual machine system comprising:
transmitting a request to a target virtual machine to access a receiving program residing on the target virtual machine;
receiving a request from the target virtual machine to examine a call stack residing on an originating virtual machine to determine whether a requesting program is permitted to access the receiving program; and
indicating to the target virtual machine if the requesting program is not permitted to access the receiving program.

2. The method of claim 1, wherein the indicating step comprises transmitting a signal indicating access is not allowed.

3. The method of claim 1, wherein the transmitting step further comprises:
invoking connectivity between the originating virtual machine and the target virtual machine;
attaching a tag ID to the request, whereby the tag ID identifies the call stack residing on the originating virtual machine; and
routing the request from the requesting program to the receiving program via said connectivity.

4. The method of claim 1, wherein the receiving step further comprises:
receiving a tag ID and information about a permission to be checked in the request from the target virtual machine;
transmitting the request to a security program residing on the originating virtual machine; and
examining the call stack residing on the originating virtual machine to determine whether the requesting program is permitted to access the receiving program.

5. A method of enforcing a security policy in a multiple virtual machine system comprising:
receiving a request from a requesting program residing on an originating virtual machine to use a service of a receiving program residing on a target virtual machine;
receiving a request from the receiving program to determine whether the requesting program is permitted to use the service of the receiving program;
checking a call stack residing on the target virtual machine;
determining whether the entire call stack is visible on the target virtual machine;
if the entire call stack is not visible, transmitting a access control request to the originating virtual machine; and
if the requesting program is not permitted to access the receiving program, sending an indication to the originating virtual machine.

6. The method of claim 5, wherein the indication from the originating virtual machine is a signal indicating access is not allowed.

7. The method of claim 5, wherein the receiving step further comprises:
invoking connectivity between the originating virtual machine and the target virtual machine;
receiving a tag ID, identifying the call stack on the originating virtual machine; and
transmitting the request to a security program residing on the target virtual machine.

8. A computer program product for enforcing a security policy in a multiple virtual machine system comprising:
computer code for transmitting a request to a target virtual machine, to access a receiving program residing on the target virtual machine;
computer code for receiving a request from the target virtual machine to examine a call stack residing on an originating virtual machine to determine whether a requesting program is permitted to access the receiving program; and
computer code for, if the requesting program is not permitted to access the receiving program, transmitting a signal to the originating virtual machine.

9. A computer program product for enforcing a security policy in a multiple virtual machine system comprising:
computer code for receiving a request from a requesting program residing on an originating virtual machine to use a service of a receiving program residing on a target virtual machine;
computer code for accessing a call stack residing on the target virtual machine to determine whether the requesting program is permitted to access the receiving program;
computer code for, if a portion of the call stack is not visible, transmitting an access control request to the originating virtual machine; and
computer code for, if the requesting program is not permitted to access the receiving program, sending an indication to the originating virtual machine.

10. The computer program product of claim 9, wherein the indication to the originating virtual machine is a signal indicating access is not allowed.

11. An electronic device comprising:
a processor for processing information; and
a memory unit, including:
computer code for transmitting a request to a target virtual machine, to access a receiving program residing on a target virtual machine;
computer code for receiving a request from the target virtual machine to examine a call stack residing on an originating virtual machine to determine whether a requesting program is permitted to access the receiving program; and
computer code for, indicating to the target virtual machine if the requesting program is not permitted to access the receiving program.

12. An electronic device comprising:
a processor for processing information; and
a memory unit, including:
computer code for receiving a request from a requesting program residing on an originating virtual machine to use a service of a receiving program residing on a target virtual machine;
computer code for accessing a call stack residing on the target virtual machine to determine whether the requesting program is permitted to access the receiving program;
computer code for, if a portion of the call stack is not visible, transmitting an access control request to the originating virtual machine; and
computer code for, indicating to the target virtual machine if the requesting program is permitted to access the receiving program.

13. A system for enforcing a security policy in a multiple virtual machine architecture comprising the steps of:
transmitting a request to a receiving program residing on a target virtual machine to access the receiving program;
examining a call stack residing on the target virtual machine to determine whether a requesting program is permitted to access the receiving program;
examining the call stack residing on an originating virtual machine to determine whether the requesting program is permitted to access the receiving program; and
if the requesting program is not permitted to access the receiving program, indicating access is not allowed.

14. The system of claim 13, wherein the indicating step comprises transmitting a signal indicating access is not allowed.

15. The system of claim 13, wherein the transmitting step further comprises:
invoking connectivity between the originating virtual machine and the target virtual machine;
attaching a tag ID to the request, whereby the tag ID identifies the call stack residing on the originating virtual machine; and
routing the request from the requesting program to the receiving program via said connectivity.

16. The system of claim 15, wherein the connectivity is implemented with an interprocess communication connection.

17. The system of claim 13, wherein the examining a call stack residing on the target virtual machine step further comprises:
transmitting a request to a security program to determine whether the requesting program is permitted to access the receiving program;
checking the call stack residing on the target virtual machine;
determining whether the entire call stack is visible on the target virtual machine; and
if the entire call stack is not visible, transmitting a access control request to originating virtual machine.

18. The method of claim 13, wherein the accessing the call stack residing on the originating virtual machine step further comprises:
receiving an access control request from the target virtual machine whereby the tag ID and information about a permission to be checked is also received;
transmitting a request to a security program to determine whether the requesting program is permitted to access the receiving program; and
examining the call stack residing on the originating virtual machine.
